(19) United States
(12) Patent Application Publication
(10) Pub. No.: US 2024/0342792 A1
(43) Pub. Date: Oct. 17, 2024

(54) IRON-BASED SOFT MAGNETIC POWDER, MAGNETIC COMPONENT USING SAME AND DUST CORE

(71) Applicants: JFE STEEL CORPORATION, Chiyoda-ku, Tokyo (JP); TOKIN Corporation, Sendai-shi, Miyagi (JP)

(72) Inventors: Takuya TAKASHITA, Chiyoda-ku, Tokyo (JP); Naoki YAMAMOTO, Chiyoda-ku, Tokyo (JP); Makoto NAKASEKO, Chiyoda-ku, Tokyo (JP); Shigeru UNAMI, Chiyoda-ku, Tokyo (JP); Masanari TOMOZAWA, Chiyoda-ku, Tokyo (JP); Akiri URATA, Sendai-shi, Miyagi (JP); Miho CHIBA, Sendai-shi, Miyagi (JP)

(73) Assignees: JFE STEEL CORPORATION, Chiyoda-ku, Tokyo (JP); TOKIN Corporation, Sendai-shi, Miyagi (JP)

(21) Appl. No.: 18/579,400

(22) PCT Filed: May 9, 2022
(86) PCT No.: PCT/JP2022/019735

§ 371 Date: Jan. 15, 2024

(30) Foreign Application Priority Data
Jul. 26, 2021 (JP) 2021-122053

(51) Int. Cl. B22F 1/102; H01F 1/26; H01F 41/02

(52) U.S. Cl. CPC B22F 1/102; H01F 1/26; H01F 41/0246; B22F 2201/02; B22F 2203/11; B22F 2301/35; B22F 2302/45; B22F 2998/10

(57) ABSTRACT

Provided is an iron-based soft magnetic powder that may be used in producing a dust core having a low iron loss. The iron-based soft magnetic powder has a crystallinity of 10% or less, volume-based median circularity (C₅₀) of 0.85 or more, and when heated to 400° C. at a heating rate of 3° C./min and held at 400° C. for 20 min in a nitrogen atmosphere, then allowed to naturally cool to room temperature, number density of Cu clusters in the powder of 1.00×10³/μm³ or more and 1.00×10⁶/m³ or less, and average Cu concentration of the Cu clusters of 30.0 at % or more.

### TECHNICAL FIELD

The present disclosure relates to an iron-based soft magnetic powder, a magnetic component using same, and a dust core.

### BACKGROUND

Magnetic cores used in electric motors, transformers, reactors, and the like are required to have high magnetic flux density and low iron loss. Conventionally, such magnetic cores have been mainly formed by stacking electrical steel sheets. However, when forming a magnetic core by stacking electrical steel sheets, the degree of freedom in shape is limited, and because electrical steel sheets having insulated surfaces are used, magnetic properties differ between a direction along a steel sheet face and a direction perpendicular to the steel sheet face, and magnetic properties in the direction perpendicular to the steel sheet face are poor. Further, increase in high-frequency iron loss caused by harmonics from switching has become a problem, in particular for iron core materials used in power conversion components using inverters, such as reactor cores, and a reduction in such loss has been sought.

Dust cores are produced by loading insulation-coated soft magnetic particles (iron powder) into a press mold and press forming, and therefore may be formed into a desired shape by the press mold. Compared to forming a magnetic core by stacking electrical steel sheets, this allows a greater degree of freedom in shape and the formation of a three-dimensional magnetic circuit. Moreover, inexpensive iron-based soft magnetic particles may be used in production of dust cores, and production is a short process and cost-effective. Further, iron-based soft magnetic particles used in dust cores have an advantage that each particle is covered with an insulating coating material and has uniform magnetic properties in all directions, and is therefore suitable for forming three-dimensional magnetic circuits. Further, due to structure, there is an advantage of lower eddy current loss, the main component of high-frequency iron loss, compared to stacked electrical steel sheets. From such perspectives, reactors and the like that utilize dust cores have recently been actively developed.

On the other hand, in order to achieve low iron loss in a dust core, not only eddy current loss needs to be reduced. Hysteresis loss, another loss that constitutes iron loss, also needs to be reduced. Further, securing at least a certain magnetic flux density is required to reduce component size. Nanocrystalline materials have been a focus of recent attention as materials capable of achieving both high magnetic flux density and low coercive force.

Nanocrystalline materials have conventionally attracted attention mainly in the thin strip field as materials that combine low coercive force and high magnetic flux density. In microstructure, the amorphous phase is responsible for low coercive force, while the nanocrystalline phase is responsible for high magnetic flux density. The average diameter of crystallites in the nanocrystalline phase is less than 50 nm in order to inhibit an increase in coercive force caused by the crystalline phase. Various developments have been made in recent years to obtain such a nanocrystalline structure in a dust core.

For example, Patent Literature (PTL) 1 describes an alloy composition consisting of Fe, B, Si, P, C, and Cu. The alloy composition in PTL 1 has a continuous strip or powder form. The alloy composition in powder form (soft magnetic powder) is produced, for example, by an atomization method, and has an amorphous phase as the main phase. Heat treatment of the soft magnetic powder under defined heat treatment conditions precipitates nanocrystals of Fe (bec Fe), resulting in Fe-based nanocrystalline alloy powder.

PTL 2 describes use of powder in which the maximum and average values of circularity of particles are at least a certain value to improve flowability when the powder is filled into a press mold.

### CITATION LIST

### Patent Literature

PTL 1: JP 2010-070852 A
PTL 2: JP 2019-21906 A

### SUMMARY

### Technical Problem

The magnetic properties of the Fe-based nanocrystalline alloy powder proposed in PTL 1 and the dust core using the Fe-based nanocrystalline alloy powder are not sufficient, and further improvement of magnetic flux density and reduction of iron loss are sought.

Only particle circularity is specified in PTL 2. However, to obtain a soft magnetic powder having good magnetic properties, controlling circularity and spheroidizing particle shape is insufficient, and securing sufficiently good soft magnetic properties in a stable manner is difficult.

It would be helpful to provide an iron-based soft magnetic powder that solves the technical problems mentioned above and may be used in producing a dust core having low iron loss.

### Solution to Problem

In order to solve the technical problems above, the inventors focused on the reduction of coercive force and diligently studied the optimization of both microstructure and particle shape of materials of a dust core, and arrived at the present disclosure. Primary features of the present disclosure are described below.

[1] An iron-based soft magnetic powder, wherein
crystallinity is 10% or less,
volume-based median circularity (C₅₀) is 0.85 or more, and
when heated to 400° C. at a heating rate of 3° C./min and held at 400° C. for 20 min in a nitrogen atmosphere, then allowed to naturally cool to room temperature, number density of Cu clusters in the powder is 1.00×10³/μm³ or more and 1.00×10⁶/m³ or less, and average Cu concentration of the Cu clusters is 30.0 at % or more.

[2] The iron-based soft magnetic powder according to aspect [1], comprising (consisting of) a chemical composition, excluding inevitable impurity, represented by a composition formula:
FeₐM_{b}Si_{c}B_{d}PₑCu_{f}
where
79.0 at %≤a+b≤84.5 at %
0 at %≤b≤10.0 at %
0 at %≤c<6.0 at %
0 at %<d≤11.0 at %
3.0 at %<e≤11.0 at %
0.2 at %≤f≤1.0 at %, and
a+b+c+d+e+f=100 at %, and
M is at least one element selected from Ni or Co.

[3] The iron-based soft magnetic powder according to aspect [2], wherein P in the composition formula is substituted by at least one element selected from C, Mn, Cr, Mo, Nb, Sn, Zr, Ta, W, Hf, or V in an amount of 4.0 at % or less.

[4] The iron-based soft magnetic powder according to any one of aspects [1] to [3], wherein O content included as inevitable impurity is 0.3 mass % or less.

[5] The iron-based soft magnetic powder according to any one of aspects [1] to [4], further comprising an insulating coating on the surface of particles constituting the iron-based soft magnetic powder.

[6] A magnetic component made using the iron-based soft magnetic powder according to aspect [5].

[7] A dust core made using the iron-based soft magnetic powder according to aspect [5].

### Advantageous Effect

According to the present disclosure, an iron-based soft magnetic powder is provided that may be used in producing a dust core having a low iron loss. More precisely, by insulating the iron-based soft magnetic powder according to the present disclosure, an insulation-coated iron-based powder having good magnetic properties (saturation magnetic flux density and coercive force) may be produced, and by using the insulation-coated iron-based powder, a dust core having low iron loss may be produced.

### DETAILED DESCRIPTION

The present disclosure is described in detail below.

### [Iron-Based Soft Magnetic Powder]

An embodiment according to the present disclosure is an iron-based soft magnetic powder (hereinafter also referred to as “soft magnetic powder”) where crystallinity is 10% or less, volume-based median circularity (C₅₀) is 0.85 or more, and when heated to 400° C. at a heating rate of 3° C./min and held at 400° C. for 20 min in a nitrogen atmosphere, then allowed to naturally cool to room temperature, number density of Cu clusters in the powder is 1.00×10³/μm³ or more and 1.00×10⁶/m³ or less, and average Cu concentration of the Cu clusters is 30.0 at % or more.

Here, the term “iron-based” means containing 50 mass % or more of Fe. The term “room temperature” here means 0° C. or more and 40° C. or less. The term “natural cooling” here means leaving in air at room temperature and being allowed to naturally cool, without using any special cooler.

### (Crystallinity)

The soft magnetic powder of the present disclosure is intended to be used as a magnetic core after green compacting, heat treatment, and nanocrystal precipitation. Accordingly, low crystallinity in the powder state is desirable and is 10% or less. The crystallinity is preferably 5% or less and may be 0%. When the crystallinity exceeds 10%, nanocrystal coarsening proceeds during the heat treatment after green compacting, resulting in a significant decrease in magnetic properties.

Crystallinity may be evaluated using a powder X-ray diffraction method, and may be calculated as the ratio of the area of crystalline peaks to the sum of the area of amorphous regions and crystalline peaks in the profile obtained by X-ray diffraction.

### (Circularity)

Hereinafter, circularity is defined by Formula (1).

$$\begin{matrix}[ Math . 1 ] & \\ C = 2 \sqrt{π A} / P & ( 1 )\end{matrix}$$

Here,
C is circularity,
A is projected area of one particle, in m², and
P is length of one particle perimeter, in m.

The measurement of circularity is as follows

The powder to be measured is dispersed on a flat surface (for example, the surface of a glass plate) by compressed air, for example, and an image of each particle is captured under a microscope. The total number of particles in the powder to be measured is 1,000 or more.

The captured images are analyzed by computer to measure projected area and length of particle perimeter for each particle. The measurement results are substituted into Formula (1) above to calculate the circularity of each particle.

The diameter of a circle that has the same area as the projected area of each particle (circle equivalent diameter) is calculated, and the volume of a sphere having the same diameter as that of the circle is calculated. Accordingly, circularity and volume of each particle is obtained, and the volume frequency at each circularity is calculable.

The circularity of all particles in the powder to be measured is arranged in ascending order, and the circularity of the particle corresponding to 50% of the sum of the volumes of all particles is taken as the median value (C₅₀). The upper limit of circularity is defined as 1, and therefore the median circularity is 1 or less. The mean value of circularity is greatly affected by the value of particles having large circularity, and therefore, in the present disclosure, the median circularity (C₅₀) is used as an index of circularity of the powder overall.

The volume-based median circularity (C₅₀) of the soft magnetic powder according to the present disclosure is 0.85 or more. The median circularity (C₅₀) is preferably 0.90 or more. The median circularity (C₅₀) is more preferably 0.95 or more. In a range described above, shape magnetic anisotropy of the particles is reduced and coercive force is sufficiently reduced.

(Cu cluster)

The soft magnetic powder according to the present disclosure, when heated to 400° C. at a heating rate of 3° C./min and held at 400° C. for 20 min in a nitrogen atmosphere, then allowed to naturally cool to room temperature, has a number density of Cu clusters in the powder of 1.00×10³/μm³ or more and 1.00×10⁶/m³ or less, and an average Cu concentration of the Cu clusters of 30.0 at % or more.

A Cu cluster is a region where Cu atoms in the powder are preferentially aggregated, and is an aggregate of atoms measured by 3D atom probe field ion microscopy, defined here as all atoms in a region (hereinafter also referred to as a “cluster region”) satisfying conditions where the aggregate of atoms contains 13 or more Cu atoms and when any of the included Cu atoms is taken as a reference, the distance between the reference Cu atom and other neighboring atoms is 0.5 nm or less.

Further, Cu concentration of Cu clusters is calculated by the following formula.

Cu concentration (at %)=number of Cu atoms in cluster region/total number of atoms in cluster region×100

For Cu clusters, nuclei of clusters are thought to exist in the amorphous phase even in an untreated state, but capturing nuclei is difficult with current technology, and quantification is difficult without heat treatment of the powder and indirect evaluation. Accordingly, the number density and the Cu concentration of Cu clusters according to the present disclosure are values measured under defined conditions, specifically when the soft magnetic powder according to the present disclosure is heated to 400° C. at a heating rate of 3° C./min and held at 400° C. for 20 min in a nitrogen atmosphere, and then allowed to naturally cool to room temperature. Powder that has been allowed to naturally cool is powder that has not undergone further heat treatment after reaching room temperature by natural cooling. Cu cluster measurement may be performed on powder immediately after reaching room temperature by natural cooling or on powder that has been left at room temperature after reaching room temperature by natural cooling.

Detection efficiency of atoms by 3D atom probe field ion microscopy in Cu cluster measurement is about 30%. When measurements are made using an instrument having a detection efficiency greater than 30%, number density and Cu concentration of Cu clusters may be calculated by back-calculating measured values from the 3D atom probe field ion microscopy to values obtained when the detection efficiency is set to 30%.

Cu clusters may be analyzed by the maximum separation method using 0.5 nm as the maximum distance dmax between Cu atoms and 13 Cu atoms as the minimum index Nmin constituting a cluster as parameters.

For 3D atom probe field ion microscopy, a needle sample may be used, sampling from the center of a particle constituting the powder to be measured and made into a needle shape by focused ion beam (FIB) processing. The tip of the needle sample is preferably 100 nm or less in diameter. The measured volume is 8×10⁻²⁴ m³ or more and 1×10⁻²⁰ m³ or less.

Ionization of needle samples may be performed by voltage load field evaporation or by laser-assisted field evaporation.

The number density of Cu clusters according to the present disclosure is 1.00×10³/μm³ or more and 1.00×10⁶/m³ or less. When the number density of Cu clusters is less than the lower limit above, the amount of nanocrystal nucleation is insufficient and sufficient magnetic flux density is not obtained. Further, when more than the upper limit above, coarsening of bcc Fe nanocrystals generated as nucleating clusters is promoted, and therefore a shorter heat treatment time is required, making securing stable properties difficult in nanocrystallization heat treatment after forming a dust core.

The average Cu concentration of Cu clusters according to the present disclosure is 30.0 at % or more. When the Cu concentration of Cu clusters is less than the lower limit above, growing bcc Fe as nuclei becomes difficult. The Cu concentration of Cu clusters is preferably 35.0 at % or more. The Cu concentration of Cu clusters is more preferably 40.0 at % or more. No upper limit is placed on Cu concentration, and Cu concentration may be 100 at %.

### (Composition)

The chemical composition of the iron-based soft magnetic powder according to the present disclosure, excluding inevitable impurity, is preferably:
composition formula: FeₐM_{b}Si_{c}B_{d}PₑCu_{f}
where
79.0 at %≤a+b 84.5 at %,
0 at %≤b≤10.0 at %,
0 at %≤c<6.0 at %,
0 at %<d≤11.0 at %,
3.0 at %<e≤11.0 at %,
0.2 at %≤f≤1.0 at %,
a+b+c+d+e+f=100 at %, and
M is at least one element selected from Ni or Co.

Such a composition allows the crystallinity of the powder to be kept to 10% or less, and after heat treatment, nanocrystals of bcc Fe may be precipitated to further improve magnetic properties.

The soft magnetic powder may contain inevitable impurity that is inevitably mixed in from production and the like. The composition formula above excludes inevitable impurity.

79.0 at %≤a+b 84.5 at %, 0 at %≤b≤10.0 at %:

M in the composition formula is at least one element selected from Ni or Co. Fe, Ni, and Co are elements responsible for the development of soft magnetic properties. In order to maintain the magnetic flux density of the powder at a high level, a+b is preferably 79.0 at % or more.

Excessive addition of Ni and Co leads to a decrease in saturation magnetic flux density and an increase in raw material cost, and therefore b is preferably kept to 10.0 at % or less. b may be 0 at %.

When an amount of Fe, Ni, Co added is excessive, a completely amorphous state in production becomes difficult, and therefore a+b is preferably 84.5 at % or less.

a+b is more preferably 84.0 at % or less. a+b is even more preferably 83.0 at % or less.

0 at %≤c<6.0 at %:

Si has an effect of inhibiting formation of Fe—P precipitates that adversely affect magnetic properties during heat treatment after green compacting. Si content may be 0 at %, but to obtain a stable nanocrystalline structure, addition of 2.0 at % or more is preferable. On the other hand, excessive addition leads to a decrease in magnetic flux density of the powder after nanocrystallization, and therefore less than 6.0 at % is preferable. c is more preferably 5.0 at % or less. c is even more preferably 4.0 at % or less.

0 at %<d≤11.0 at %:

B is an element responsible for formation of a stable amorphous state. However, excessive addition leads to a decrease in magnetic flux density of the powder after nanocrystallization, and therefore 11.0 at % or less is preferable. d is more preferably 10 at % or less. d is even more preferably 9.5 at % or less. d is preferably 1 at % or more.

3.0 at %<e≤11.0 at %:

Addition of P further facilitates the formation of an amorphous state, and therefore addition of more than 3.0 at % is preferable. P also reduces the coercive force of the powder. On the other hand, excessive addition increases the likelihood of formation of Fe—P precipitates that significantly increase coercive force during heat treatment for the purpose of nanocrystallization after forming, leading to a decrease in magnetic flux density of the powder after nanocrystallization, and therefore 11.0 at % or less is preferable. e is more preferably 10.0 at % or less. e is even more preferably 9.0 at % or less.

0.2 at %≤f≤1.0 at %:

Cu is an essential element for the formation of Cu clusters and is preferably added at 0.2 at % or more. On the other hand, excessive addition creates a situation of excessive Cu clusters and degrades magnetic properties after nanocrystallization, and therefore 1.0 at % or less is preferable. f is preferably 0.3 at % or more. f is preferably 0.8 at % or less.

P substitution:

P in the composition formula may be substituted by at least one element selected from C, Mn, Cr, Mo, Nb, Sn, Zr, Ta, W, Hf, or V in an amount up to 4.0 at % or less. By substituting some P with these elements, atoms of greatly different sizes are mixed in, and an amorphous state is more likely to form. Further, homogenization of element distribution in the amorphous microstructure is contributed to, which may lower coercive force. When substituted, the amount is preferably 0.3 at % or more. The amount is more preferably 1.0 at % or more.

Inevitable impurity:

O is listed as an inevitable impurity, but O content is preferably suppressed to 0.3 mass % or less, because excessive O contamination leads to a decrease in magnetic flux density and an increase in coercive force. The O content is more preferably suppressed to 0.2 mass % or less, and the O content may be 0 mass %.

### [Production Method]

The soft magnetic powder according to the present disclosure may be produced using a water atomizing method or gas atomization, in which water or gas is sprayed onto molten metal to atomize and solidify by cooling. Alternatively, the soft magnetic powder may be obtained by processing powder obtained by a grinding method or an oxide reduction method.

Crystallinity is adjustable by controlling water pressure, water volume, and the like during water atomizing in the case of a water atomizing method, or by controlling gas pressure, gas flow rate, and the like during gas atomizing in the case of gas atomization.

The resulting powder may be classified by various methods to adjust to a defined circularity and particle size. For example, when a water atomizing method or gas atomization are used, circularity may be set to a defined range by adjusting the pressure of the water or gas being blown to a low level. Alternatively, circularity may be adjusted by smoothing particle surfaces or by removing particles having low circularity by classification and selection by sieve. For example, particle surfaces of powder obtained by a grinding method, an oxide reduction method, or a typical high-pressure water atomizing method or gas atomization may be smoothed and/or classification and selection by sieve may be used remove particles having low circularity.

Number density and concentration of Cu clusters are adjustable by heat treatment of the powder obtained by atomization under an inert or reduced pressure atmosphere. The heat treatment may also serve as a drying process after dehydration in the case of a water-atomized powder. Temperature of the heat treatment is preferably 100° C. or more. Temperature of the heat treatment is preferably 300° C. or less. When the temperature is in the range above, sufficient effect is obtainable to suppress excessive cluster production and help avoid degradation of magnetic properties after nanocrystallization. Duration of the heat treatment may be varied as desired, but for productivity reasons, 12 h or less is preferable.

The iron-based soft magnetic powder according to the present disclosure may have an apparent density of 3.70 Mg/m³ or more. Apparent density is preferably 4.00 Mg/m³ or more. Industrially achievable apparent density is 5.00 Mg/m³ or less. The average particle diameter (D₅₀) may be 100 μm or less. The average particle diameter is preferably 20 μm or more. The average particle diameter is preferably 40 μm or less.

Apparent density may be measured by a method defined in Japanese Industrial Standard JIS Z 2504.

The average particle diameter (D₅₀) is the particle diameter obtained when a volume-based cumulative particle size distribution measured by laser diffraction or laser diffusion is 50%.

### [Insulating Coating]

The iron-based soft magnetic powder according to the present disclosure may be provided with an insulating coating on surfaces of particles constituting the powder.

The insulating coating is not particularly limited and may be an inorganic or organic insulating coating. One or both of inorganic and organic insulating coating may be used.

As an inorganic insulating coating, a film containing an aluminum compound is preferable. A film containing aluminum phosphate is more preferable. The inorganic insulating coating may be a chemical conversion layer.

As an organic insulating coating, an organic resin coating is preferable. As an organic resin, examples include silicone resin, phenol resin, epoxy resin, polyamide resin, polyimide resin, and the like. These may be included alone or in any ratio of two or more. Among these, a film containing silicone resin is more preferable.

The insulating coating may be a single layer coating or a multilayer coating consisting of two or more layers. A multilayer film may be a multilayer film consisting of the same type of film or a multilayer film consisting of different types of films.

As silicone resins, examples include, but are not limited to brands such as SH805, SH806A, SH840, SH997, SR620, SR2306, SR2309, SR2310, SR2316, DC12577, SR2400, SR2402, SR2404, SR2405, SR 2406, SR2410, SR2411, SR2416, SR2420, SR2107, SR2115, SR2145, SH6018, DC-2230, DC3037, QP8-5314, produced by Dow Corning Toray Co., Ltd., KR-251, KR-255, KR-114A, KR-112, KR-2610B, KR-2621-1, KR-230B, KR-220, KR-285, K295, KR-2019, KR-2706, KR-165, KR-166, KR-169, KR-2038, KR-221, KR-155, KR-240, KR-101-10, KR-120, KR-105, KR-271, KR-282, KR-311, KR-211, KR-212, KR-216, KR-213, KR-217, KR-9218, SA-4, KR-206, ES-1001N, ES-1002T, ES1004, KR-9706, KR-5203, KR-5221, produced by Shin-Etsu Chemical Co., Ltd., and the like. These silicone resins may be used alone or in any ratio of two or more silicone resins.

As an aluminum compound, any compound containing aluminum may be used, such as aluminum phosphate, nitrate, acetate, hydroxide, and the like. These compounds may be used alone or in any ratio of two or more compounds.

Coating containing an aluminum compound may be a film that is mainly an aluminum compound or may consist of an aluminum compound. The coating may further contain a metal compound containing a metal other than aluminum. As metals other than aluminum, examples include Mg, Mn, Zn, Co, Ti, Sn, Ni, Fe, Zr, Sr, Y, Cu, Ca, V, Ba, and the like. These metals may be used alone or in any ratio of two or more metals. As metal compounds containing a metal other than aluminum, examples include phosphates, carbonates, nitrates, acetates, hydroxides, and the like. These metal compounds may be used alone or in any ratio of two or more metal compounds. The metal compound is preferably soluble in a solvent such as water, and more preferably a water-soluble metal salt.

The amount of the insulating coating is not particularly limited. Relative to the iron-based soft magnetic powder, the amount of the insulating coating is preferably 0.1 mass % or more. The amount of the insulating coating is preferably 5 mass % or less.

The iron-based soft magnetic powder according to the present disclosure may contain a substance different from the insulating coating described above at at least one of in the insulating coating, under the insulating coating, or above the insulating coating. As such a substance, examples include a surfactant to improve wettability, a binding agent for inter-particle binding, an additive for pH adjustment, and the like. The total amount of the substance relative to the insulating coating is preferably 10 mass % or less.

The method of forming the insulating coating is not particularly limited. The method of forming the insulating coating is preferably wet processing. As wet processing, an example is mixing a coating solution for forming the insulating coating with the soft magnetic powder.

The method of mixing is not particularly limited. Preferred methods include, for example, stirring and mixing the soft magnetic powder and the coating solution in a tank such as an attritor or Henschel® mixer (Henschel is a registered trademark in Japan, other countries, or both), or supplying and mixing the soft magnetic powder in a fluid state with the coating solution using a rolling fluid coating device or the like.

The coating solution may be entirely supplied to the soft magnetic powder before or immediately after the start of mixing, or may be supplied several times during mixing. Alternatively, a droplet feeder, a spray, or the like may be used to continuously supply the coating solution during mixing.

### [Dust Core]

Another embodiment of the present disclosure is a dust core made using the iron-based soft magnetic powder.

The method of producing the dust core is not particularly limited, and any method may be used. For example, the iron-based soft magnetic powder according to the present disclosure may be charged into a press mold and pressed to desired dimensions and shape to obtain the dust core. The iron-based soft magnetic powder preferably includes the insulating coating.

Pressing is not particularly limited and any method may be used. Examples include room temperature forming, press mold lubrication forming, and the like.

Forming pressure may be determined according to the application, but an increase in the forming pressure increases compressed density and improves magnetic properties. The forming pressure is preferably 490 MPa or more. The forming pressure is more preferably 686 MPa or more.

A lubricant may be used in pressing. The lubricant may be applied to the press mold wall or added to the iron-based soft magnetic powder. The use of a lubricant reduces friction between the press mold and the powder during pressing, further inhibiting a reduction in green density, and also reduces friction during removal from the press mold, preventing cracking of the formed body (dust core) during removal.

The lubricant is not particularly limited. Examples include metallic soaps such as lithium stearate, zinc stearate, calcium stearate, and the like, and waxes such as fatty acid amide.

Heat treatment may be applied to the resulting dust core. The heat treatment may be expected to reduce hysteresis loss caused by strain removal and increase the strength of the formed body. Heat treatment conditions may be determined according to appropriate nanocrystallization temperature of the powder. Temperature is preferably 200° C. or more. Temperature is preferably 700° C. or less. Time is preferably 5 min or more. Time is preferably 300 min or less. The heat treatment may be performed in any atmosphere, such as air, an inert atmosphere, a reducing atmosphere, a vacuum, or the like. For uniform nanocrystallization in the dust core, applying an excessively fast heating rate in the heat treatment is not desirable. The heating rate is preferably 10° C./min or less. The heating rate is more preferably 5° C./min or less. From the viewpoint of productivity, the heating rate is preferably 1° C./min or more. The heating rate is preferably 2° C./min or more.

### [Applications]

By using the iron-based soft magnetic powder according to the present disclosure as a starting material, the dust core having low iron loss may be produced. The iron-based soft magnetic powder according to the present disclosure is particularly preferable as a starting material for the production of magnetic components such as transformers, inductors, magnetic cores for motors, and the like.

### EXAMPLES

Although further detail is provided below with reference to Examples, the disclosure is not limited in any way to the following Examples.

### (Evaluation of Iron-Based Soft Magnetic Powder)

Evaluation of the iron-based soft magnetic powders of the Examples was performed as follows.

### (1) Circularity

For each evaluation, the iron-based soft magnetic powder was dried and loaded into a particle image imaging analyzer (Morphologi G3, produced by Spectris Co., Ltd.). The Morphologi G3 is a device that has the ability to image particles with a microscope and analyze the resulting images.

The dried iron-based soft magnetic powder was dispersed on glass by air at 500 kPa so that the shape of individual particles could be determined. The powder dispersed on glass was then observed with a Morphologi G3-attached microscope, and magnification was automatically adjusted so that the number of particles in the field of view was 5,000. Image interpretation was then performed on the 5,000 particles in the field of view, and the circularity diameter of each particle was automatically calculated. The median circularity (C₅₀) was determined as the individual particles were arranged in ascending order of circularity.

### (2) Crystallinity

The evaluation of the crystallinity of the iron-based soft magnetic powders was performed by a method using powder X-ray diffraction as described previously.

(3) Number density of Cu clusters and concentration of Cu clusters

For each evaluation, the iron-based soft magnetic powder was heated to 400° C. at 3° C./min and held at 400° C. for 20 min in a nitrogen atmosphere, and then allowed to naturally cool to room temperature. Needle samples of the iron-based soft magnetic powder after cooling were prepared as described previously, and Cu clusters were evaluated by 3D atom probe field ion microscopy (3DAP), as described previously.

Detection efficiency of atoms by 3DAP was about 30%. Two needle samples were prepared, one ionized by voltage load field evaporation and the other by laser-assisted field evaporation, and measurements were performed. Number density and Cu concentration are the average of these values.

### (4) Magnetic Properties

Magnetic properties were evaluated for the iron-based soft magnetic powders after the heat treatment of (3), above. Saturation magnetic moment was measured using a vibrating sample magnetometer (VSM), and coercive force and saturation magnetic flux density measurements were calculated. The maximum magnetic field was set at 1,300 kA/m.

### (Preparation and Evaluation of Dust Core)

Each of the iron-based soft magnetic powders obtained for the Examples (not heat treated as in (3)) was given an insulating coating by adding an insulating coating solution and mixing. The insulating coating solution was a silicone resin (SR2400 produced by Dow Corning Toray Co., Ltd.) having 60 mass % resin content, further diluted with xylene, and this solution was used to coat the iron-based soft magnetic powder with 3 mass % of resin. After mixing, the mixture was allowed to stand in air at room temperature for 10 h to dry. After drying, heat treatment was performed at 150° C. for 60 min for resin hardening. Next, the insulation-coated iron-based soft magnetic powder was filled into a press mold coated with lithium stearate and pressed into a dust core (outer diameter 38 mm, inner diameter 25 mm, height 6 mm). The forming pressure was set at 1,470 MPa and the forming done once. To improve the strength of the formed body, the temperature was raised from room temperature to 400° C. at 3° C./min then held for 20 min in a furnace under a N₂ atmosphere. After heat treatment, removal from the furnace under the N₂ atmosphere, and air-cooling to room temperature, the resulting specimen was used as a dust core test piece.

The test piece was coiled (100 turns on the primary side and 20 turns on the secondary side), and iron loss (0.1 T, 20 kHz) was measured using a high-frequency iron loss measuring instrument (produced by Metron Giken Co., Ltd.).

### Examples 1

Iron-based soft magnetic powders were prepared by quenching solidification of molten steel having the chemical compositions listed in Table 1 by a water atomizing method. No. 1 to No. 7 in Table 1 were adjusted for crystallinity and circularity by appropriate adjustment of water pressure and molten steel injection rate. Specifically, the water pressure during water atomization was varied in No. 1 to No. 4, with No. 1, No. 2, No. 3, and No. 4 in order of increasing water pressure (No. 1 had the highest water pressure and No. 4 had the lowest water pressure). The lower the water pressure, the higher the degree of crystallinity. The water pressure of sprayed water and the injection speed of molten steel during water atomization was varied in No. 5 to No. 7, with No. 5, No. 6, and No. 7 in order of decreasing water pressure (No. 5 had the lowest water pressure and No. 7 had the highest water pressure), and No. 5, No. 6, and No. 7 in order of decreasing molten steel injection speed (No. 5 was the slowest and No. 7 the fastest). No. 8 to No. 12 were water atomized under the same conditions as No. 1.

Next, the powder produced by the water atomizing method was subjected to a drying process that also served to adjust the density of Cu clusters. For the drying treatment, No. 1 to No. 7 were treated at a furnace temperature of 180° C. under an air atmosphere for 6 h, and then under reduced pressure of 10 Pa relative to atmospheric pressure for another 6 h.

Under the air atmosphere in the drying treatment, No. 8 was dried at 120° C. for 6 h, No. 9 was dried at 80° C. for 6 h, No. 10 was dried at 220° C. for 6 h, No. 11 was dried at 290° C. for 6 h, and No. 12 was dried at 360° C. for 6 h.

Table 1 lists the measurement results of the properties of the soft magnetic powders obtained. The pass/fail criteria for the soft magnetic powders were as follows.

Magnetic flux density of 1.65 T or more and coercive force of 100 A/m or less . . . ⊚Magnetic flux density of 1.65 T or more and coercive force more than 100 A/m and 150 A/m or less . . . ∘

Magnetic flux density less than 1.65 T and/or coercive force more than 150 A/m . . . x

Here, “◯” and “⊚” results indicate a pass, while an “x” result indicates a fail.

TABLE 1

| | | | | | | Properties of iron-based soft magnetic powder | | | | |
|---|---|---|---|---|---|---|---|---|---|---|
| | | | | | | | Average | | | |
| | Chemical composition of iron-based | | | | | Apparent | particle | | | Cu cluster |
| | soft magnetic powder (at %) | | | | | density | size | Crystallinity | C₅₀ | density |
| No. | Fe | Si | B | P | Cu | (Mg/m³) | (μm) | (%) | (—) | (×10⁴/μm³) |
| 1 | 81.65 | 3.0 | 9.0 | 6.0 | 0.35 | 3.88 | 33 | 1 | 0.90 | 1.00 |
| 2 | 81.65 | 3.0 | 9.0 | 6.0 | 0.35 | 3.93 | 29 | 5 | 0.90 | 0.91 |
| 3 | 81.65 | 3.0 | 9.0 | 6.0 | 0.35 | 3.97 | 26 | 10 | 0.90 | 1.13 |
| 4 | 81.65 | 3.0 | 9.0 | 6.0 | 0.35 | 4.14 | 33 | 15 | 0.90 | 1.08 |
| 5 | 81.65 | 3.0 | 9.0 | 6.0 | 0.35 | 3.81 | 35 | 1 | 0.95 | 1.21 |
| 6 | 81.65 | 3.0 | 9.0 | 6.0 | 0.35 | 3.88 | 27 | 1 | 0.85 | 1.11 |
| 7 | 81.65 | 3.0 | 9.0 | 6.0 | 0.35 | 4.11 | 35 | 1 | 0.83 | 1.29 |
| 8 | 81.65 | 3.0 | 9.0 | 6.0 | 0.35 | 4.10 | 33 | 1 | 0.95 | 0.10 |
| 9 | 81.65 | 3.0 | 9.0 | 6.0 | 0.35 | 3.82 | 33 | 1 | 0.95 | 0.05 |
| 10 | 81.65 | 3.0 | 9.0 | 6.0 | 0.35 | 3.78 | 28 | 1 | 0.95 | 20.0 |
| 11 | 81.65 | 3.0 | 9.0 | 6.0 | 0.35 | 3.75 | 30 | 1 | 0.95 | 95.0 |
| 12 | 81.65 | 3.0 | 9.0 | 6.0 | 0.35 | 3.85 | 29 | 1 | 0.95 | 300 |

| | Properties of iron-based soft magnetic powder | | | | | |
|---|---|---|---|---|---|---|
| | Average Cu | Saturation | | | | |
| | concentration | magnetic flux | Coercive | | Dust core | |
| | in cluster | density | force | | Iron loss | |
| No. | (at %) | (T) | (A/m) | Evaluation | (kW/m³) | Remarks |
| 1 | 51.0 | 1.70 | 65 | ⊚ | 202 | Example |
| 2 | 60.0 | 1.71 | 80 | ⊚ | 219 | Example |
| 3 | 49.0 | 1.71 | 140 | ◯ | 275 | Example |
| 4 | 61.0 | 1.70 | 300 | X | 430 | Comparative Example |
| 5 | 49.0 | 1.72 | 69 | ⊚ | 206 | Example |
| 6 | 54.0 | 1.72 | 120 | ◯ | 255 | Example |
| 7 | 53.0 | 1.72 | 160 | X | 303 | Comparative Example |
| 8 | 38.0 | 1.65 | 90 | ⊚ | 206 | Example |
| 9 | 33.0 | 1.62 | 100 | X | 217 | Comparative Example |
| 10 | 67.0 | 1.74 | 88 | ⊚ | 234 | Example |
| 11 | 73.0 | 1.77 | 140 | ◯ | 270 | Example |
| 12 | 82.0 | 1.78 | 210 | X | 344 | Comparative Example |

According to Table 1, the Examples corresponding to the iron-based soft magnetic powder according to the present disclosure had excellent magnetic properties, with pass/fail criteria results of “◯“and “⊚”. Further, the dust cores made using the Examples of the iron-based soft magnetic powder all had iron losses below 300 kW/m³ and excellent magnetic properties.

### Examples 2

To study the effects of Si, B, P, and Cu additions, iron-based soft magnetic powders having the chemical compositions listed in Table 2 were prepared. The method of preparation was the same as that of No. 1 of Examples 1, except that the chemical composition of the molten steel used was changed.

TABLE 2

| | | | | | | Properties of iron-based soft magnetic powder | | | | |
|---|---|---|---|---|---|---|---|---|---|---|
| | | | | | | | Average | | | |
| | Chemical composition of iron-based | | | | | Apparent | particle | | | Cu cluster |
| | soft magnetic powder (at %) | | | | | density | size | Crystallinity | C₅₀ | density |
| No. | Fe | Si | B | P | Cu | (Mg/m³) | (μm) | (%) | (—) | (×10⁴/μm³) |
| 13 | 81.70 | 3.0 | 9.0 | 6.0 | 0.30 | 3.96 | 31 | 1 | 0.90 | 1.01 |
| 14 | 81.50 | 3.0 | 9.0 | 6.0 | 0.50 | 3.73 | 33 | 1 | 0.90 | 2.31 |
| 15 | 81.20 | 3.0 | 9.0 | 6.0 | 0.80 | 3.95 | 30 | 1 | 0.90 | 2.75 |
| 16 | 81.00 | 3.0 | 9.0 | 6.0 | 1.00 | 4.07 | 31 | 1 | 0.90 | 3.44 |
| 17 | 81.65 | 0.0 | 9.0 | 9.0 | 0.35 | 4.11 | 29 | 1 | 0.89 | 1.26 |
| 18 | 81.65 | 5.5 | 9.0 | 3.5 | 0.35 | 4.12 | 25 | 2 | 0.95 | 1.20 |
| 19 | 81.65 | 3.0 | 7.0 | 8.0 | 0.35 | 4.09 | 34 | 1 | 0.89 | 1.28 |
| 20 | 81.65 | 3.0 | 5.0 | 10.0 | 0.35 | 3.92 | 30 | 1 | 0.88 | 1.15 |
| 21 | 81.65 | 3.0 | 4.0 | 11.0 | 0.35 | 3.81 | 27 | 1 | 0.88 | 1.21 |
| 22 | 81.65 | 5.5 | 1.5 | 11.0 | 0.35 | 3.77 | 30 | 3 | 0.88 | 1.05 |
| 23 | 79.05 | 3.4 | 10.3 | 6.9 | 0.35 | 4.02 | 25 | 1 | 0.90 | 0.94 |
| 24 | 80.65 | 3.2 | 9.5 | 6.3 | 0.35 | 3.85 | 34 | 1 | 0.90 | 1.18 |
| 25 | 83.65 | 2.7 | 8.0 | 5.3 | 0.35 | 4.04 | 30 | 1 | 0.91 | 1.21 |
| 26 | 81.50 | 0.0 | 9.0 | 9.0 | 0.50 | 3.82 | 27 | 1 | 0.90 | 1.93 |
| 27 | 81.50 | 5.5 | 9.0 | 3.5 | 0.50 | 3.75 | 31 | 1 | 0.94 | 1.95 |
| 28 | 81.50 | 3.0 | 7.0 | 8.0 | 0.50 | 3.84 | 33 | 1 | 0.90 | 2.13 |
| 29 | 81.50 | 3.0 | 5.0 | 10.0 | 0.50 | 4.04 | 29 | 1 | 0.89 | 1.94 |
| 30 | 81.50 | 3.0 | 4.0 | 11.0 | 0.50 | 3.79 | 26 | 1 | 0.88 | 2.11 |
| 31 | 81.50 | 5.5 | 1.5 | 11.0 | 0.50 | 3.95 | 27 | 3 | 0.87 | 2.19 |
| 32 | 79.00 | 3.4 | 10.2 | 6.9 | 0.50 | 4.16 | 31 | 1 | 0.90 | 2.16 |
| 33 | 80.50 | 3.2 | 9.5 | 6.3 | 0.50 | 3.99 | 29 | 1 | 0.90 | 2.07 |
| 34 | 83.50 | 2.7 | 8.0 | 5.3 | 0.50 | 3.82 | 31 | 1 | 0.90 | 2.22 |

| | Properties of iron-based soft magnetic powder | | | | | |
|---|---|---|---|---|---|---|
| | Average Cu | Saturation | | | | |
| | concentration | magnetic flux | Coercive | | Dust core | |
| | in cluster | density | force | | Iron loss | |
| No. | (at %) | (T) | (A/m) | Evaluation | (kW/m³) | Remarks |
| 13 | 46.7 | 1.69 | 64 | ⊚ | 195 | Example |
| 14 | 64.0 | 1.70 | 53 | ⊚ | 189 | Example |
| 15 | 76.0 | 1.72 | 50 | ⊚ | 181 | Example |
| 16 | 76.2 | 1.73 | 52 | ⊚ | 183 | Example |
| 17 | 50.3 | 1.71 | 55 | ⊚ | 186 | Example |
| 18 | 51.3 | 1.70 | 70 | ⊚ | 200 | Example |
| 19 | 53.4 | 1.70 | 57 | ⊚ | 194 | Example |
| 20 | 53.8 | 1.70 | 51 | ⊚ | 182 | Example |
| 21 | 49.9 | 1.70 | 49 | ⊚ | 188 | Example |
| 22 | 56.5 | 1.70 | 50 | ⊚ | 184 | Example |
| 23 | 55.0 | 1.71 | 63 | ⊚ | 198 | Example |
| 24 | 57.3 | 1.71 | 67 | ⊚ | 198 | Example |
| 25 | 51.4 | 1.71 | 72 | ⊚ | 199 | Example |
| 26 | 58.6 | 1.71 | 48 | ⊚ | 186 | Example |
| 27 | 59.6 | 1.72 | 70 | ⊚ | 198 | Example |
| 28 | 57.2 | 1.68 | 51 | ⊚ | 184 | Example |
| 29 | 58.9 | 1.71 | 44 | ⊚ | 181 | Example |
| 30 | 60.3 | 1.67 | 43 | ⊚ | 183 | Example |
| 31 | 55.8 | 1.67 | 44 | ⊚ | 177 | Example |
| 32 | 58.3 | 1.70 | 56 | ⊚ | 190 | Example |
| 33 | 59.2 | 1.71 | 57 | ⊚ | 197 | Example |
| 34 | 61.2 | 1.69 | 63 | ⊚ | 196 | Example |

No. 13 to No. 34 in Table 2 are Examples that satisfy the defined composition formula, the pass/fail criteria results were all “(”, and the iron losses of the dust cores were all 200 kW/m³ or less, indicating excellent magnetic properties.

### Examples 3

To study the effects of substituting some Fe with Ni, Co, iron-based soft magnetic powders having the chemical compositions listed in Table 3 were prepared. The method of preparation was the same as that of No. 1 of Examples 1, except that the chemical composition of the molten steel used was changed.

TABLE 3

| | | | | | | | | Properties of iron-based soft magnetic powder | | | | |
|---|---|---|---|---|---|---|---|---|---|---|---|---|
| | Chemical composition of iron-based | | | | | | | | Average | | | |
| | soft magnetic powder (at %) | | | | | | | Apparent | particle | | | Cu cluster |
| | | M | | | | | | density | size | Crystallinity | C₅₀ | density |
| No. | Fe | Ni | Co | Si | B | P | Cu | (Mg/m³) | (μm) | (%) | (—) | (×10⁴/μm³) |
| 35 | 79.65 | 2.0 | — | 3.0 | 9.0 | 6.0 | 0.35 | 3.98 | 27 | 1 | 0.90 | 1.03 |
| 36 | 76.65 | 5.0 | — | 3.0 | 9.0 | 6.0 | 0.35 | 4.04 | 34 | 1 | 0.90 | 0.99 |
| 37 | 71.65 | 10.0 | — | 3.0 | 9.0 | 6.0 | 0.35 | 3.90 | 28 | 1 | 0.90 | 1.02 |
| 38 | 79.65 | — | 2.0 | 3.0 | 9.0 | 6.0 | 0.35 | 3.87 | 28 | 1 | 0.90 | 0.98 |
| 39 | 76.65 | — | 5.0 | 3.0 | 9.0 | 6.0 | 0.35 | 4.00 | 30 | 1 | 0.90 | 1.00 |
| 40 | 71.65 | — | 10.0 | 3.0 | 9.0 | 6.0 | 0.35 | 4.05 | 26 | 1 | 0.90 | 1.00 |
| 41 | 79.65 | 1.0 | 1.0 | 3.0 | 9.0 | 6.0 | 0.35 | 3.73 | 30 | 1 | 0.90 | 0.97 |
| 42 | 76.65 | 2.5 | 2.5 | 3.0 | 9.0 | 6.0 | 0.35 | 3.90 | 27 | 1 | 0.90 | 1.01 |
| 43 | 71.65 | 5.0 | 5.0 | 3.0 | 9.0 | 6.0 | 0.35 | 3.82 | 25 | 1 | 0.90 | 0.98 |

| | Properties of iron-based soft magnetic powder | | | | | |
|---|---|---|---|---|---|---|
| | Average Cu | Saturation | | | | |
| | concentration | magnetic flux | Coercive | | Dust core | |
| | in cluster | density | force | | Iron loss | |
| No. | (at %) | (T) | (A/m) | Evaluation | (kW/m³) | Remarks |
| 35 | 52.3 | 1.70 | 53 | ⊚ | 193 | Example |
| 36 | 53.1 | 1.69 | 50 | ⊚ | 189 | Example |
| 37 | 50.9 | 1.68 | 52 | ⊚ | 186 | Example |
| 38 | 55.0 | 1.70 | 48 | ⊚ | 186 | Example |
| 39 | 49.5 | 1.72 | 49 | ⊚ | 187 | Example |
| 40 | 54.8 | 1.72 | 49 | ⊚ | 185 | Example |
| 41 | 53.2 | 1.72 | 50 | ⊚ | 181 | Example |
| 42 | 57.9 | 1.72 | 51 | ⊚ | 188 | Example |
| 43 | 56.3 | 1.65 | 52 | ⊚ | 190 | Example |

No. 35 to No. 43 in Table 3 are Examples that satisfy the defined composition formula, the pass/fail criteria results were all “⊚”, and the iron losses of the dust cores were all 200 kW/m³ or less, indicating excellent magnetic properties.

### Examples 4

To study the effects of substituting some P with Mn, Cr, Mo, Nb, Sn, Zr, Tr, W, Hf, V, iron-based soft magnetic powders having the chemical compositions listed in Table 4 were prepared. The method of preparation was the same as that of No. 1 of Examples 1, except that the chemical composition of the molten steel used was changed.

TABLE 4
Chemical composition of iron-based soft magnetic powder (at %)

| | | | | | | | Properties of iron-based soft magnetic powder | | | | |
|---|---|---|---|---|---|---|---|---|---|---|---|
| | Chemical composition of iron-based | | | | | | | Average | | | |
| | soft magnetic powder (at %) | | | | | | Apparent | particle | | | Cu cluster |
| | | | | | P substituted | | density | size | Crystallinity | C₅₀ | density |
| No. | Fe | Si | B | P | elements | Cu | (Mg/m³) | (μm) | (%) | (—) | (×10⁴/μm³) |
| 44 | 81.65 | 3.0 | 9.0 | 5.5 | Mn: 0.5 | 0.35 | 4.00 | 32 | 0 | 0.93 | 0.97 |
| 45 | 81.65 | 3.0 | 9.0 | 5.5 | Cr: 0.5 | 0.35 | 3.93 | 26 | 0 | 0.92 | 0.98 |
| 46 | 81.65 | 3.0 | 9.0 | 5.5 | Mo: 0.5 | 0.35 | 3.93 | 35 | 0 | 0.92 | 1.29 |
| 47 | 81.65 | 3.0 | 9.0 | 5.5 | Nb: 0.5 | 0.35 | 3.87 | 31 | 0 | 0.87 | 1.17 |
| 48 | 81.65 | 3.0 | 9.0 | 5.5 | Sn: 0.5 | 0.35 | 3.94 | 27 | 0 | 0.89 | 0.97 |
| 49 | 81.65 | 3.0 | 9.0 | 5.0 | Mn: 1.0 | 0.35 | 4.08 | 27 | 0 | 0.91 | 1.15 |
| 50 | 81.65 | 3.0 | 9.0 | 5.0 | Cr: 1.0 | 0.35 | 3.74 | 34 | 0 | 0.91 | 1.30 |
| 51 | 81.65 | 3.0 | 9.0 | 5.0 | Mo: 1.0 | 0.35 | 4.11 | 26 | 0 | 0.94 | 0.90 |
| 52 | 81.65 | 3.0 | 9.0 | 5.0 | Nb: 1.0 | 0.35 | 4.00 | 28 | 0 | 0.94 | 1.18 |
| 53 | 81.65 | 3.0 | 9.0 | 5.0 | Sn: 1.0 | 0.35 | 3.95 | 30 | 0 | 0.94 | 1.24 |
| 54 | 81.65 | 3.0 | 9.0 | 4.0 | Mn: 2.0 | 0.35 | 3.86 | 32 | 0 | 0.91 | 1.12 |
| 55 | 81.65 | 3.0 | 9.0 | 4.0 | Cr: 2.0 | 0.35 | 3.72 | 34 | 0 | 0.90 | 0.95 |
| 56 | 81.65 | 3.0 | 9.0 | 4.0 | Mo: 2.0 | 0.35 | 3.74 | 35 | 0 | 0.90 | 0.96 |
| 57 | 81.65 | 3.0 | 9.0 | 4.0 | Nb: 2.0 | 0.35 | 3.95 | 31 | 0 | 0.89 | 1.19 |
| 58 | 81.65 | 3.0 | 9.0 | 4.0 | Sn: 2.0 | 0.35 | 3.94 | 32 | 0 | 0.91 | 1.27 |
| 59 | 81.65 | 3.0 | 9.0 | 4.0 | Mn: 1.0, Cr: 1.0 | 0.35 | 3.76 | 30 | 0 | 0.90 | 1.19 |
| 60 | 81.65 | 3.0 | 9.0 | 4.0 | Mn: 1.0, Mo: 1.0 | 0.35 | 3.91 | 28 | 0 | 0.91 | 1.26 |
| 61 | 81.65 | 3.0 | 9.0 | 4.0 | Mn: 1.0, Nb: 1.0 | 0.35 | 3.88 | 28 | 0 | 0.90 | 1.21 |
| 62 | 81.65 | 3.0 | 9.0 | 4.0 | Mn: 1.0, Sn: 1.0 | 0.35 | 4.17 | 35 | 0 | 0.90 | 0.91 |
| 63 | 81.65 | 3.0 | 9.0 | 5.5 | Zr: 0.5 | 0.35 | 4.08 | 35 | 0 | 0.88 | 0.95 |
| 64 | 81.65 | 3.0 | 9.0 | 5.5 | Ta: 0.5 | 0.35 | 3.72 | 35 | 0 | 0.86 | 1.03 |
| 65 | 81.65 | 3.0 | 9.0 | 5.5 | W: 0.5 | 0.35 | 4.20 | 34 | 0 | 0.88 | 1.19 |
| 66 | 81.65 | 3.0 | 9.0 | 5.5 | Hf: 0.5 | 0.35 | 4.09 | 27 | 0 | 0.89 | 1.07 |
| 67 | 81.65 | 3.0 | 9.0 | 5.5 | V: 0.5 | 0.35 | 3.79 | 34 | 0 | 0.88 | 0.97 |
| 68 | 81.65 | 3.0 | 9.0 | 5.5 | Zr: 1.0 | 0.35 | 4.00 | 28 | 0 | 0.90 | 1.30 |
| 69 | 81.65 | 3.0 | 9.0 | 5.5 | Ta: 1.0 | 0.35 | 4.16 | 32 | 0 | 0.90 | 1.19 |
| 70 | 81.65 | 3.0 | 9.0 | 5.5 | W: 1.0 | 0.35 | 3.82 | 25 | 0 | 0.89 | 1.03 |
| 71 | 81.65 | 3.0 | 9.0 | 5.5 | Hf: 1.0 | 0.35 | 3.96 | 33 | 0 | 0.95 | 1.07 |
| 72 | 81.65 | 3.0 | 9.0 | 5.5 | V: 1.0 | 0.35 | 3.94 | 26 | 0 | 0.90 | 1.01 |

| | Properties of iron-based soft magnetic powder | | | | | |
|---|---|---|---|---|---|---|
| | Average Cu | Saturation | | | | |
| | concentration | magnetic flux | Coercive | | Dust core | |
| | in cluster | density | force | | Iron loss | |
| No. | (at %) | (T) | (A/m) | Evaluation | (kW/m³) | Remarks |
| 44 | 56.7 | 1.69 | 51 | ⊚ | 182 | Example |
| 45 | 54.2 | 1.70 | 58 | ⊚ | 191 | Example |
| 46 | 58.9 | 1.72 | 50 | ⊚ | 189 | Example |
| 47 | 50.2 | 1.67 | 56 | ⊚ | 196 | Example |
| 48 | 59.0 | 1.73 | 52 | ⊚ | 187 | Example |
| 49 | 52.3 | 1.67 | 58 | ⊚ | 196 | Example |
| 50 | 55.7 | 1.68 | 58 | ⊚ | 197 | Example |
| 51 | 55.4 | 1.71 | 56 | ⊚ | 187 | Example |
| 52 | 57.3 | 1.67 | 55 | ⊚ | 193 | Example |
| 53 | 53.2 | 1.70 | 54 | ⊚ | 184 | Example |
| 54 | 51.9 | 1.69 | 54 | ⊚ | 184 | Example |
| 55 | 54.0 | 1.67 | 50 | ⊚ | 190 | Example |
| 56 | 55.5 | 1.69 | 53 | ⊚ | 183 | Example |
| 57 | 52.0 | 1.68 | 58 | ⊚ | 191 | Example |
| 58 | 51.9 | 1.72 | 55 | ⊚ | 188 | Example |
| 59 | 50.6 | 1.72 | 54 | ⊚ | 193 | Example |
| 60 | 56.0 | 1.71 | 56 | ⊚ | 188 | Example |
| 61 | 60.1 | 1.67 | 55 | ⊚ | 194 | Example |
| 62 | 50.1 | 1.70 | 54 | ⊚ | 187 | Example |
| 63 | 54.9 | 1.71 | 52 | ⊚ | 196 | Example |
| 64 | 56.3 | 1.68 | 57 | ⊚ | 197 | Example |
| 65 | 54.2 | 1.68 | 59 | ⊚ | 186 | Example |
| 66 | 59.3 | 1.72 | 50 | ⊚ | 199 | Example |
| 67 | 52.1 | 1.70 | 55 | ⊚ | 189 | Example |
| 68 | 50.9 | 1.69 | 52 | ⊚ | 196 | Example |
| 69 | 57.4 | 1.66 | 51 | ⊚ | 181 | Example |
| 70 | 51.2 | 1.71 | 58 | ⊚ | 196 | Example |
| 71 | 51.9 | 1.71 | 53 | ⊚ | 194 | Example |
| 72 | 51.9 | 1.72 | 53 | ⊚ | 183 | Example |

No. 44 to No. 72 in Table 4 are Examples in which a portion of P was substituted with a defined element, the pass/fail criteria results were all “⊚”, and the iron losses of the dust cores were all 200 kW/m³ or less, indicating excellent magnetic properties.

### Examples 5

To study the effect of O content as inevitable impurity in soft magnetic powders, powders having the chemical compositions listed as No. 73 to No. 75 in Table 5 were prepared. The method of preparation was the same as that of No. 1 of Examples 1, except that the chemical compositions of the molten steel used was changed. The difference in O content was due to the adjustment of oxygen concentration in the atmosphere during spraying.

TABLE 5

| | | | | | | | Properties of iron-based soft magnetic powder | | | | |
|---|---|---|---|---|---|---|---|---|---|---|---|
| | Chemical composition of iron-based | | | | | | | Average | | | |
| | soft magnetic powder (at %) | | | | | | Apparent | particle | | | Cu cluster |
| | (O is an impurity) | | | | | | density | size | Crystallinity | C₅₀ | density |
| No. | Fe | Si | B | P | Cu | O | (Mg/m³) | (μm) | (%) | (—) | (×10⁴/μm³) |
| 73 | 81.65 | 3.0 | 9.0 | 5.5 | 0.35 | 0.25 | 4.05 | 25 | 1 | 0.92 | 0.98 |
| 74 | 81.65 | 3.0 | 9.0 | 5.5 | 0.35 | 0.10 | 3.85 | 28 | 1 | 0.92 | 0.98 |
| 75 | 81.65 | 3.0 | 9.0 | 5.5 | 0.35 | 0.05 | 4.11 | 30 | 1 | 0.92 | 1.29 |

| | Properties of iron-based soft magnetic powder | | | | | |
|---|---|---|---|---|---|---|
| | Average Cu | Saturation | | | | |
| | concentration | magnetic flux | Coercive | | Dust core | |
| | in cluster | density | force | | Iron loss | |
| No. | (at %) | (T) | (A/m) | Evaluation | (kW/m³) | Remarks |
| 73 | 51.4 | 1.70 | 53 | ⊚ | 180 | Example |
| 74 | 52.2 | 1.70 | 42 | ⊚ | 150 | Example |
| 75 | 52.0 | 1.72 | 36 | ⊚ | 140 | Example |

No. 73 to No. 75 in Table 5 are Examples in which the O content, an inevitable impurity, was suppressed to 0.3 mass % or less, the pass/fail criteria results of the iron-based soft magnetic powder were all “0”, and the iron losses of the dust cores were all 200 kW/m³ or less, indicating excellent magnetic properties.

1. An iron-based soft magnetic powder, wherein
crystallinity is 10% or less,
volume-based median circularity (C₅₀) is 0.85 or more, and
when heated to 400° C. at a heating rate of 3° C./min and held at 400° C. for 20 min in a nitrogen atmosphere, then allowed to naturally cool to room temperature, number density of Cu clusters in the powder is 1.00×10³/μm³ or more and 1.00×10⁶/μm³ or less, and average Cu concentration of the Cu clusters is 30.0 at % or more.

2. The iron-based soft magnetic powder according to claim 1, comprising a chemical composition, excluding inevitable impurity, represented by a composition formula:
FeₐM_{b}Si_{c}B_{d}PₑCu_{f}
where
79.0 at %≤a+b 84.5 at %
0 at %≤b≤10.0 at %
0 at %≤c<c 6.0 at %
0 at %<d≤11.0 at %
3.0 at %<e<11.0 at %
0.2 at %≤f≤1.0 at %, and
a+b+c+d+e+f=100 at %, and
M is at least one element selected from Ni or Co.

3. The iron-based soft magnetic powder according to claim 2, wherein P in the composition formula is substituted by at least one element selected from C, Mn, Cr, Mo, Nb, Sn, Zr, Ta, W, Hf, or V in an amount of 4.0 at % or less.

4. The iron-based soft magnetic powder according to claim 1, wherein O content included as inevitable impurity is 0.3 mass % or less.

5. The iron-based soft magnetic powder according to claim 1, further comprising an insulating coating on the surface of particles constituting the iron-based soft magnetic powder.

6. A magnetic component made using the iron-based soft magnetic powder according to claim 5.

7. A dust core made using the iron-based soft magnetic powder according to claim 5.

8. The iron-based soft magnetic powder according to claim 2, wherein O content included as inevitable impurity is 0.3 mass % or less.

9. The iron-based soft magnetic powder according to claim 3, wherein O content included as inevitable impurity is 0.3 mass % or less.

10. The iron-based soft magnetic powder according to claim 2, further comprising an insulating coating on the surface of particles constituting the iron-based soft magnetic powder.

11. The iron-based soft magnetic powder according to claim 3, further comprising an insulating coating on the surface of particles constituting the iron-based soft magnetic powder.

12. The iron-based soft magnetic powder according to claim 4, further comprising an insulating coating on the surface of particles constituting the iron-based soft magnetic powder.

13. The iron-based soft magnetic powder according to claim 8, further comprising an insulating coating on the surface of particles constituting the iron-based soft magnetic powder.

14. The iron-based soft magnetic powder according to claim 9, further comprising an insulating coating on the surface of particles constituting the iron-based soft magnetic powder.
